(19) United States
(12) Patent Application Publication
(10) Pub. No.: US 2012/0017873 A1
(43) Pub. Date: Jan. 26, 2012

(54) SPARK ADVANCE ADJUSTMENT

(75) Inventors: Alain Lunati, La Fare Les Oliviers (FR); Johan Fournel, Robion (FR); Thierry Gergaud, Istres (FR); Guillaume Biteau, Le Havre (FR)

(73) Assignee: SP3H, AIX-EN-PROVENCE (FR)

(21) Appl. No.: 12/518,759

(22) PCT Filed: Dec. 12, 2007
(86) PCT No.: PCT/FR07/02055

§ 371 Date: Jul. 27, 2011

(30) Foreign Application Priority Data
Dec. 14, 2006 (FR) 0655506

(51) Int. Cl. F02P 5/15

(52) U.S. Cl. 123/406.19

(57) ABSTRACT

The invention relates to an additional process for the spark advance adjustment. This process is used for the tight adjustment of the spark advance angle depending on the structure of the fuel molecules from at least one mapping. This adjustment covers the entire operation range of the engine. This process reduces the pollutant emission when the engine is cold, as soon as the engine starting and stabilisation phase when the engine control and adjustment systems are not in a closed adjustment loop yet. The spark advance adjustment can also be used for operation at the rattle boundary during high load operation and at the engine full load.

The invention relates to a controlled-spark engine arranged to allow the adjustment of the spark advance value.

In order best to meet the energy demands of the coming decades and reduce vehicle fuel consumption, emissions of CO2 and pollutants, all engine builders and vehicle manufacturers are suggesting more and more complex strategies for electronic engine management.

These strategies often involve the use of small engines with similar power and performance features to less enhanced, larger engines. The minimisation of engine size with the same power and performance is commonly known as “downsizing”.

Considerable efforts have been made in the management of vehicle ignition, which is still a source of considerable polluting emissions.
Downsizing:

The development of these smaller engines integrates adapted engine control laws in the engine computer (poor mixture and stratified load, homogeneous combustion zone, engine scavenging by managing the EGR valve, turbo pressure, etc.). Downsizing makes it possible to improve engine performance by shifting their operation to high loads (sustained engine stress) as a positive consequence of improved specific consumption and reduced emissions of pollutants (C, HC, NOx) and CO2.

However, for controlled-spark engines, the improvement of performance, consumption and polluting emissions by reducing engine size, which often operates with a high load, is limited by the appearance of knocking, the phenomenon of out-of-control self-ignition of the fuel.

Self-ignition is ignition in which a mix of fuel/combustive agent is subjected to a high enough pressure and temperature causing it to spontaneously ignite. This phenomenon is the operating principle of diesel engines.

In a controlled-spark engine, knocking is a very sudden phenomenon of abnormal combustion caused by massive self-ignition of the last fractions of the burnt mix not reached by the flame front from the spark plug, which is particularly harmful and destructive.

The appearance of knocking in a controlled-spark engine is caused by the following factors:
engine design and the interaction of aerodynamics/combustion;
engine control settings;
the operating load of the engine; knocking generally appears with high loads;
the fuel used, which, according to the molecules that form it, will offer greater or lesser resistance to self-ignition.

For a given engine and fuel, the appearance of knocking can be easily reduced by making the engine operate in over-advance. This means controlling the spark of the air-fuel mix well upstream from the top dead centre.

Methods according to current regulations use a knock detector that informs the engine control unit of the appearance of this abnormal combustion. The engine control unit advances the spark by a considerable step, so as to rapidly move away from conditions that are favourable to knocking. During subsequent cycles, the engine control unit generally marks a waiting time before making several jumps forward to return close to the optimum spark advance.
Cold Engine Start:

Engine adjustments for cold starting and the stabilisation period after starting are critical in the sense that the conditions for correct starting and minimisation of polluting emissions are not simultaneously met.

Manufacturers and engine builders must make sure that the engine will start up cold even in difficult conditions. This leads to very high safety margins in the adjustments, but is detrimental to polluting emissions. The main engine control parameters managing ignition/polluting emissions are the initial spark advance angle and the richness of the air-fuel mix.

To guarantee engine starting and stabilisation, the conventional adjustments consist of working with a rich mix and in spark sub-advance.
Impact of Spark Over-Advance and Sub-Advance

Working in spark over-advance reduces knocking but, at the same time, reduces engine performance and increases fuel consumption. Furthermore, starting in over-advance encourages the creation of NOx and HC pollutants.

Working in spark sub-advance during the start-up and stabilisation phases delays the control of the richness in a closed loop and therefore the operation of the three-way catalyst.

Therefore, the solutions proposed until now, including electronic management, are suitable for current engines and standards.

However, these solutions are not sufficient for the latest generation of engines, which are small and often operate with high loads, in which the major constraint is to manage knocking. Indeed, intensive and no-longer isolated use of the current knocking regulation method, by changing the spark advance with considerable advance steps and a slower return to the optimum, disrupts the conditions for optimising the operation of the engine in a closed loop and thus the engine approval, consumption and pollution balance at the exhaust output.

Likewise, current cold-starting solutions are no longer sufficient in view of future environmental regulations.

The method according to the invention allows improved management of spark advance, mainly for the problems associated with cold starting and knocking.

For this purpose, the invention relates to a controlled-spark engine comprising an electronic/digital engine control module, said module comprising at least one system for managing the spark advance and means for determining the molecular structure of the fuel supplying it, said determination means making it possible to obtain markers of the molecular structure of the fuel, said engine being characterised in that the management system is arranged to use a plurality of functions (a₁, a₂, . . . , aₙ) for correlating the markers (c₁, c₂, . . . , cₙ) of the molecular structure of the fuel with the spark advance value, said functions (a₁, a₂, . . . , aₙ) being sorted by decreasing order of correlation with the spark advance adjustment values, in order to adjust the value of the spark advance angle according to said functions (a₁, a₂, . . . , aₙ).

Thus, for current controlled-spark engines, the invention enables the implementation of a complementary spark advance adjustment strategy. This strategy allows tight adjustment of the spark advance angle to take into account variations in the self-ignition delay of the fuels, which depends on the nature and the molecular structure of the molecules that make up the fuel. This adjustment covers the entire operation range of the engine. The strategy reduces pollutant emissions when the engine is cold, from the starting and stabilisation phases of the engine when the engine control and regulation systems have not yet entered a closed regulation loop. The spark advance adjustment also makes it possible to operate at the knocking boundary during high load operation and with the engine at full load.

For “downsized” controlled-spark engines: For these engines, which often operate with high or full loads and in which the major constraint is the appearance of knocking, the invention allows the implementation of an additional strategy for managing spark advance. This strategy guarantees an optimisation of the spark advance in the engine starting phase, as well as increasing the reduction of engine size thanks to fine engine control at the knocking boundary.

By frequently operating the engine with high load or full load, the invention provides a more efficient solution to the issues of reducing CO2 emissions and consumption while reducing the highly penalizing triggering and intervention of the current knocking-control system to ensure the safety of the engine.

In both these cases, the consideration of molecular structure markers of the fuel enables a better estimation of the self-ignition delay of the mix and thus of the optimum setting value for the spark advance in accordance with the operating parameters of the engine.

Thus, the invention makes it possible to pre-set the tightest possible values of the spark advance angle in the engine control unit, according to the top dead centre.

The invention provides finer engine control and optimisation, with the advantage of conserving the current safe knocking-management module.

Further aims and advantages of the invention will become apparent from the following description, made in reference to the appended drawings.

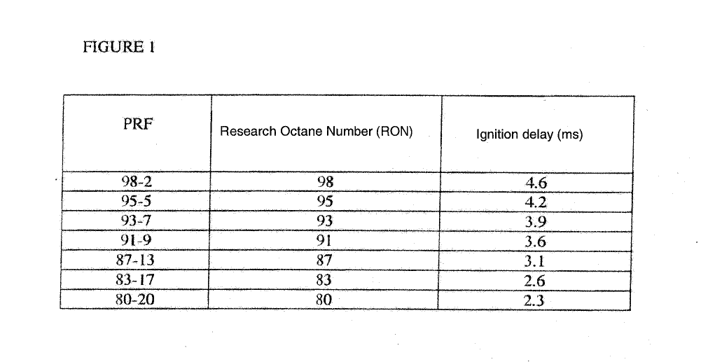

FIG. 1 is a table showing examples of the variation of the self-ignition delays of several reference fuels that cover the average variability of the quality of petrol fuel manufactured by refineries around the world.

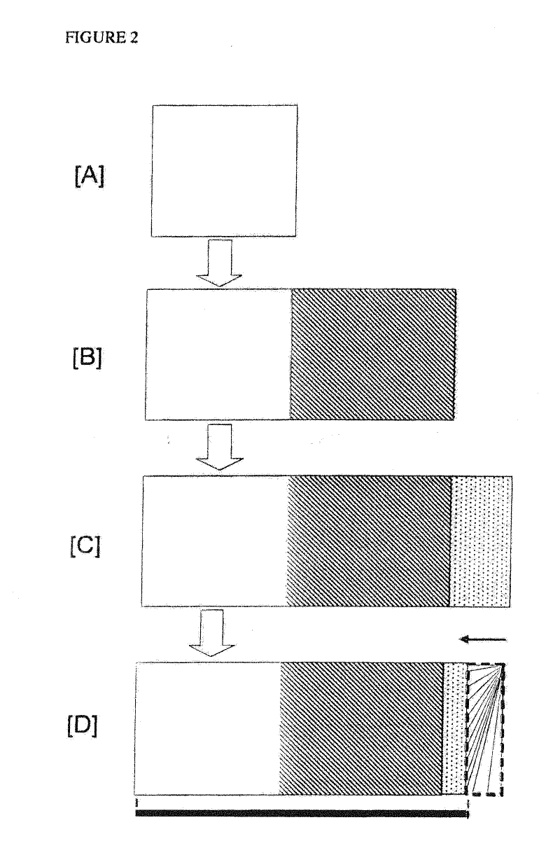

FIG. 2 is a diagram showing an example of the operation of a spark advance control strategy including an adjustment according to the molecular structure of the fuel.

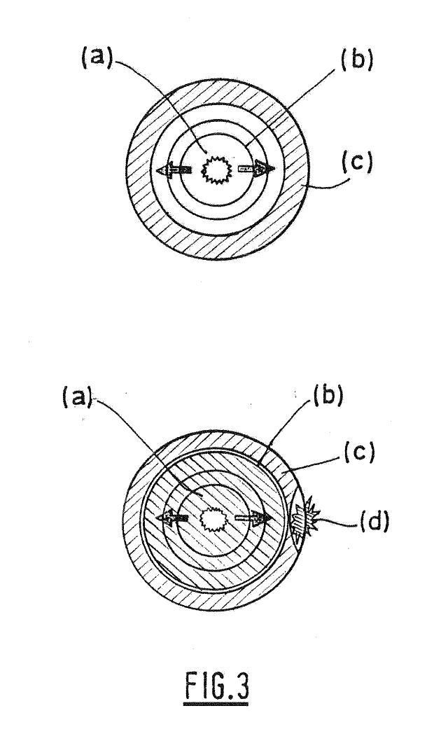

FIG. 3 is a diagrammatic representation of the appearance of knocking.

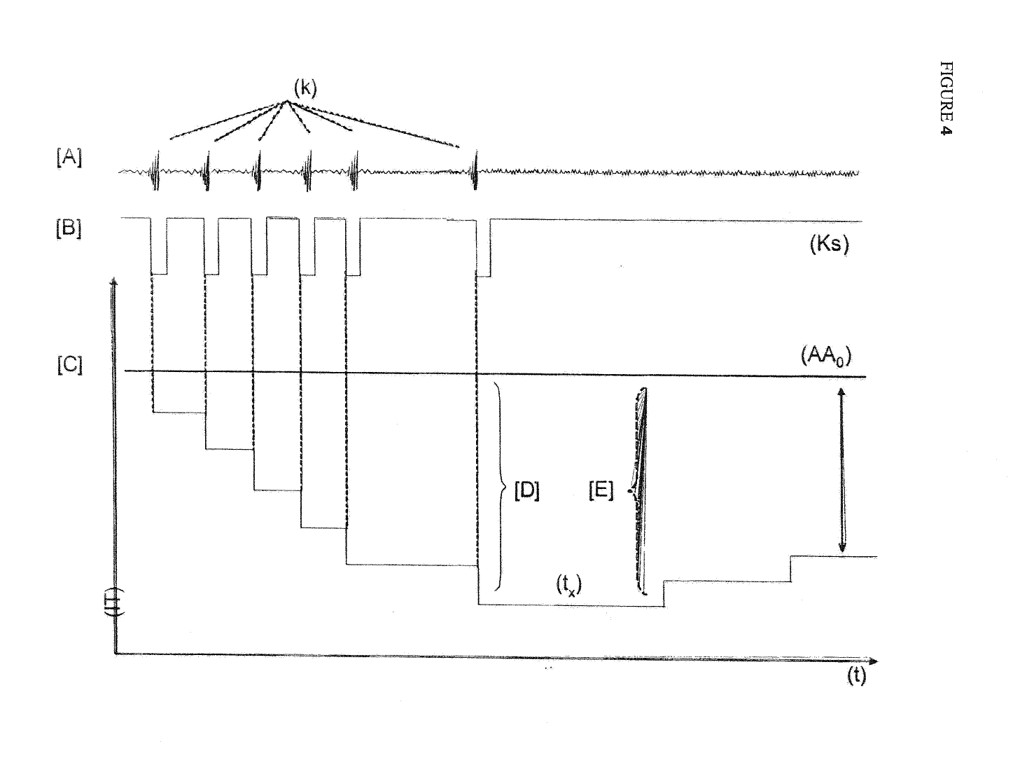

FIG. 4 is a diagrammatic representation of the operation of the knocking-management system.

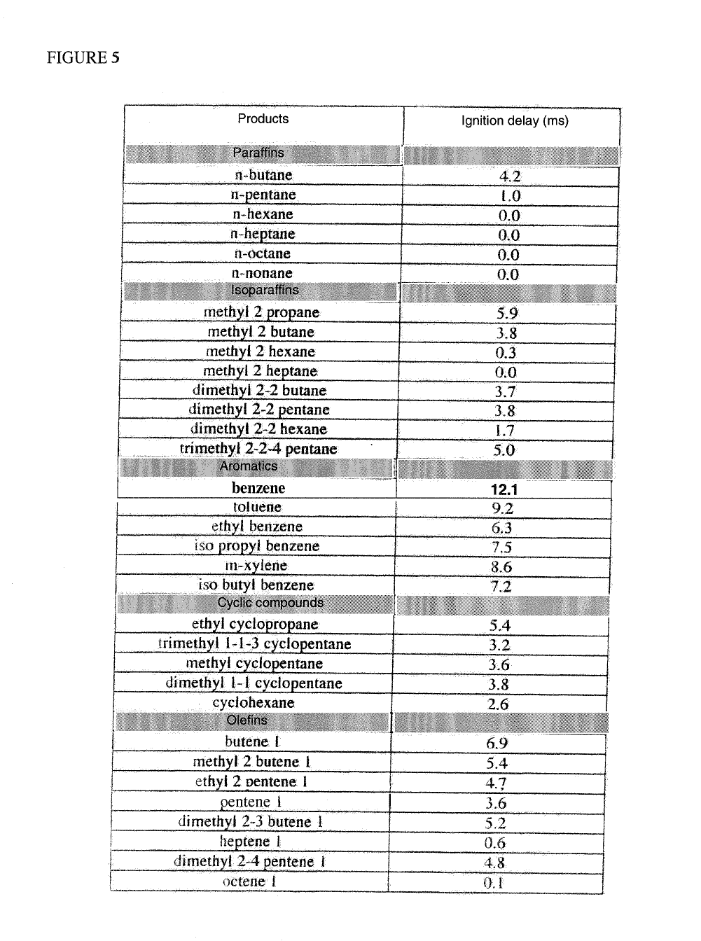

FIG. 5 is a table showing the various self-ignition delays for a given play of P and T, of molecules potentially present in petrol-type fuel. These molecules are classified into families (paraffins, aromatics, etc.)

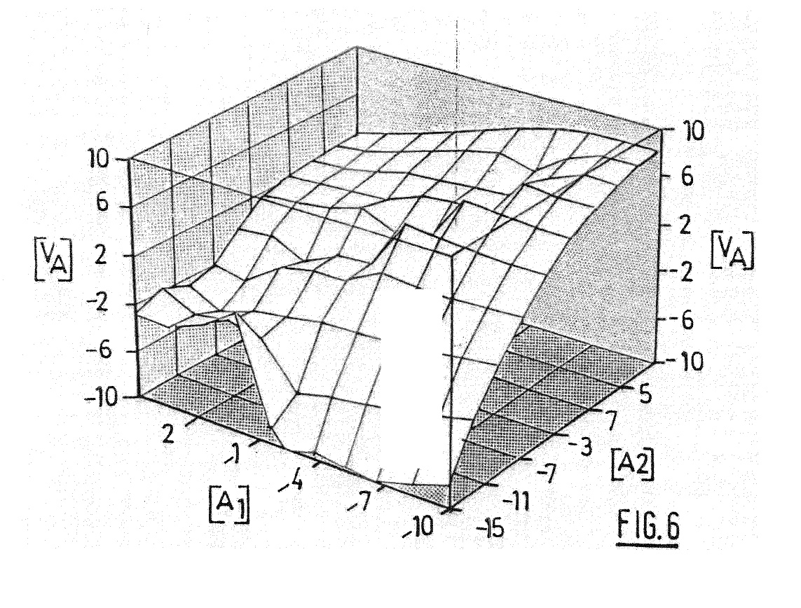

FIG. 6 is a graphic showing an example of mapping the calibration of spark advance adjustment according to the molecular structure of the fuels.

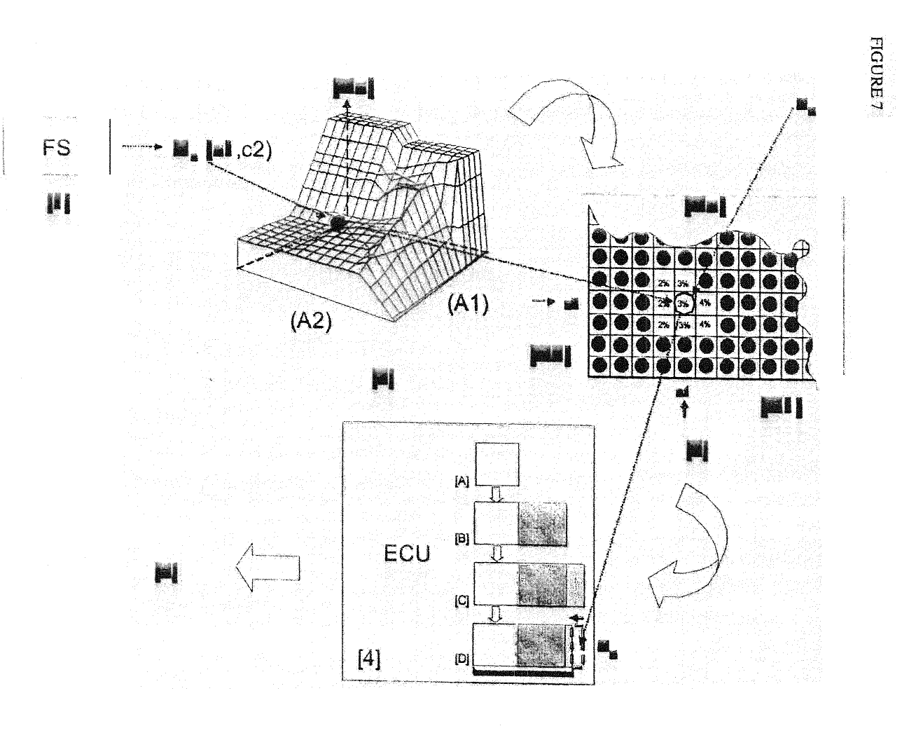

FIG. 7 is a diagrammatic representation of the steps involved in calculating the spark advance angle adjustment based on determining two markers of the molecular structure of the fuel and a map of the spark advance adjustment.

A vehicle equipped with an internal-combustion heat engine with controlled spark works by sucking in air from the atmosphere and mixing it with a liquid hydrocarbon made up of hydrocarbon molecules (essentially carbon, hydrogen and oxygen) to burn it in order to recover the energy released when the atomic bonds are broken.

The operating principle of the controlled-spark management system is to cause a spark plug to emit a spark in order to ignite the air-fuel mix in the combustion chamber at the desired moment to maximise the energy yield of the combustion by making the combustion pressure peak coincide with an ideal position of the piston/crankshaft.

However, there exists a delay of several milliseconds between the moment when the spark is produced and the moment when the ignition of the air-fuel mix expands, corresponding to the start of the live combustion phase of the mix and to obtaining a maximum pressure peak in the combustion chamber.

The electronically controlled spark advance is expressed in degrees of an angle of rotation of the crankshaft and makes it possible to synchronise the start of combustion, marked by the appearance of the pressure peak in the combustion chamber, with an optimum, predetermined position of the piston in the combustion chamber.

The advance value depends, among other factors, on the speed of rotation of the engine (engine rating) and the intake pressure in the intake manifold.

Generally speaking, the spark must be produced earlier when the engine rating is at its highest, and later when the rating is lower. Furthermore, the spark must also be advanced when the air pressure in the manifold is low (high depression) and vice-versa.

A non-optimised spark advance value can have a significant effect on the polluting emissions and on the vehicle's driveability. Under certain engine operating conditions, a spark advance angle that is too close to the top dead centre can cause the appearance of an out-of-control phenomenon of spontaneous self-ignition of the air-fuel mix, called knocking, and an increase of unburned hydrocarbons (HC) and nitrogen oxides (NOx).

Conversely, an excessively low spark advance value can cause partial combustion of the air-fuel mix and result in a loss of energy conversion efficiency of the engine, this loss of power causing a loss of driveability and an increase of polluting emissions.

However, the optimal value of the spark advance associated with the ignition delay also depends on other very important factors such as fuel quality as shown in FIG. 1 and several parameters of engine design and engine operation. An electronic control system determining the optimum spark advance value is therefore provided in order to take into account the need to estimate the calculation of the air-fuel mix self-ignition delay as accurately as possible. As can be seen in FIG. 1, the variation in the self-ignition delay between two fuels distributed in Europe (equivalent to reference fuels PRF 98-2 and PRF 91-9) exceeds 25%.

The core of the spark advance system is a system for regulating engine parameters, a system which maximises engine efficiency by adjusting the instant value of the spark advance angle in real time to take into account the air-fuel mix ignition delay (FIG. 1) and to obtain the maximum combustion pressure peak when the position of the piston is outside the top dead centre, in the position ideally predefined during the engine tuning process.

When tuning the engine, the adjustment and the optimum value of the spark advance angle are currently obtained in several successive steps, according to predetermined strategies associated with engine operation. They are stored in the form of various maps and control strategies in the ECU memory bank (FIG. 2).

During the engine starting phase, the ECU determines in a first step the initial spark advance angle based on a value set by default in reference to an angle of the crankshaft in advance in relation to the top dead centre of the piston. This value remains as the reference value throughout the starting phase and immediately after starting while the engine rotation speed remains under a predetermined threshold value corresponding to an unstable engine rating.

As soon as the ECU receives the signal, such as that the engine has started, the spark advance will be calculated and optimised in a feedback loop in a succession of steps, by adjusting the value of the initial advance angle. These corrections are made in a second step, adjusting the value of the advance according to values coming from various sensors and comparing them to the laws and maps stored in the ECU's memory banks. In this step, the initial spark advance angle is corrected by the ECU microprocessor by a basic advance value calculated using information relating to the volume of air in the intake manifold, the speed of rotation of the engine (rating), the position of the choke and the engine temperature.

In a third step, a final adjustment is applied to calculate the optimum spark advance angle, to take into account, among other information from the engine computer, mainly the following:
a correction due to engine temperature if the engine is cold or in extreme weather conditions,
a correction due to an excessive engine temperature,
a correction to stabilise the idle engine rating,
a correction due to atmospheric pressure,
a correction according to the exhaust gas recycling rate (EGR),
a correction associated with the richness-management strategy,
a correction associated with the transitory rating management strategy (deceleration followed by acceleration),
a correction associated with the knocking-management strategy,
the minimum and maximum authorised advance angle values, which cannot be lower or higher than the set MIN and MAX values, etc.

It is therefore the management of the knocking phenomenon by electronic spark-advance control that reduces the appearance of this type of abnormal combustion. The latter occurs when the engine operating conditions lead to variable amplitude oscillations of pressure levels and a high temperature of the gases in the combustion chamber, due to explosive self-ignition of the air-fuel mix taking place before the normal combustion mechanism by propagation of a flame front (FIG. 3). As can be seen in FIG. 3, the spark (a) is caused by the spark plug. It enables the propagation of the flame front (b) towards the areas of the mix not yet reached (c). If the combustion speed is too slow, a massive self-ignition of the last fraction of the carburised mix not reached by the flame front takes place (d), causing engine knocking.

The knocking phenomenon is the result of a mismatch between the resistance to self-ignition of the air-fuel mix in the chamber and the operating characteristics of the engine at a given moment (pressure/temperature) as well as to engine design parameters.

This phenomenon is well known since the 1930s, and many solutions to avoid damaging the engine during its operation, in the event of persistent or intense knocking, have been put forward since the 1970s, in particular by André Douad and Joseph Rialan from the French Oil Institute (FR 2,337,261),

Thus, after more than 20 years, the implementation of electronic engine control units (ECU) and engine control laws and strategies have allowed engine knocking management to be integrated on board the vehicle, in a closed regulation loop using information from a specific sensor of an acoustic vibration detector (piezoelectric). This makes it possible to take into account the variable quality of the fuel available at the pump.

Indeed, manufacturers tune their engines according to tests conducted using standardised reference fuels, but must then be able to make the engine work under any conditions, taking into account the variable quality of fuel and, in particular, its resistance to self-ignition.

For this purpose, the control loop acts as a corrective solution to secure the engine in response to an abnormal, isolated phenomenon. It allows the detection of latent knocking and can provide a correction by reducing the spark advance angle. Advancing the spark in relation to the top dead centre has a direct effect on combustion, since it reduces the temperature and pressure inside the engine's combustion chamber, allowing it to reach normal operating parameters.

FIG. 4 shows the operation of the knocking-management system. This operation is described as follows:
[A] Oscillations (k) caused by the appearance of a self-ignition in the combustion chamber appear on one of the cylinders.
[B] The knock detector (Ks) detects them and transmits a “pulse” signal to the control system.
[C] In each pulse of the detector (Ks), the control system modifies the spark advance (AA₀) step by step (over-advance) for the entire duration of the abnormal combustion, until the knocking stops.
[D] After a certain predefined time (tₓ), the system re-advances the spark advance value so as to tend towards the original value (AA₀).

When knocking appears (FIG. 4), the knock detector converts the vibration from the oscillations of the amplitude of the gas pressure and temperature level in the combustion chamber into a current value which is sent back to the engine control module. According to the programmed setting values, the ECU advances the spark in relation to the top dead centre by a fixed step until the knocking disappears. Once the self-ignition phenomenon stops, the ECU stops advancing the spark and begins to return towards an optimum solution by delaying the spark.

In the event of persistent knocking, there is also a procedure for securing the engine that makes it possible to modify the basic advance value stored in the memory, delaying the spark in the entire range of operation of the engine. This process of establishing a safety margin has a negative impact on engine performance and consumption for a relatively long period of time, which requires refilling the fuel tank several times with normal-quality fuel or to correct the fault in the engine computer memory.

Likewise, complete work has been conducted in national, European and worldwide legislation for more than thirty years to define standards for fuels with increasingly enhanced specifications to resist the self-ignition phenomenon (increase of the fuel octane rating RON 90, 95, 98, etc., a characteristic of the resistance to self-ignition of the mix).

Despite everything, when starting the vehicle, the lack of information from the various sensors, in particular the richness sensor, does not allow optimisation of the spark advance, and supplies a single initial spark advance value regardless of fuel quality. This phase has considerable responsibility in generating the majority of HC, CO and NOx pollutant emissions.

The difficulty for engine builders will be in finding a compromise between the initial setting value or the calculation of the basic spark advance to avoid excessive adjustment by the knocking management and correction module.

This is why manufacturers are paying very careful attention to developing engine architectures (chamber/cylinder head/piston design, superchargers, etc.) in order to reduce the appearance of knocking.

Until now, knocking management control by the ECU, using a knocking sensor, was enough to respond to and correct the abnormal and isolated appearance of the self-ignition phenomenon, in the case of a mismatch between the operating parameters of the engine with full or high load and the ability of the air-fuel mix to resist self-ignition.

Despite everything, this solution is not enough for controlling the phenomenon if it occurs in a recurring manner, although in most cases of engine operation the spark advance angle must be as close as possible to the appearance of knocking in order to optimise fuel consumption.

Some people have suggested controlling the operation of the engine parameters using a fuel sensor based on measuring the dielectric constant (U.S. Pat. No. 5,150,653) or refraction indices (DE 4,219,142) or acoustic waves (US 2005/0247289), but the applications are limited since they do not directly take into account the impact of the interactions between the variation of the molecular structure of a fuel and the engine adjustments.

However, patent application FR 2,883,602 suggests using a dedicated sensor, linked with the identification of the molecular structure of the fuel. The invention is based on applying the method according to this patent application to adjusting the value of the spark advance angle.

It is therefore possible to relate the value of the spark advance angle directly to the molecular structure of the fuel that supplies the engine.

FIG. 2 shows an example of the operation of a spark advance control strategy including an adjustment due to the molecular structure of the fuel. In this example, this adjustment causes a decrease of the advance value in step [D].

Step [A]—starting and post-starting—loop open
Advance angle=Initial spark advance angle
Step [B]—engine in operation—loop closed
Advance angle=Initial angle+Basic advance angle
Step [C]—engine in operation—loop closed
Advance angle=Initial advance angle+Basic advance angle+Corrective advance angle
Step [D]—engine in operation—loop closed
Advance angle=Initial advance angle+Basic advance angle+Corrective advance angle+adjustment according to the adjustment due to the molecular structure of the fuel.

The self-ignition delay of the fuel depends closely on the structure of the molecules that make it up (FIG. 5). In particular, the molecular structure of the fuel depends on the type and number of molecules in the hydrocarbon backbone. By knowing the molecular structure of the fuel it is therefore possible easily to calculate its self-ignition delay. Petrol for an controlled-spark engine according to standard EN 228 is made up on average of fifty to one hundred molecules with 4 to more than 9 carbon atoms. These molecules are associated with hydrocarbon families.

The pure hydrocarbon families can be grouped together, for example, into:
saturated hydrocarbons (alkanes with linear open carbon chains commonly known as paraffins, alkanes with branched open carbon chains commonly known as isoparaffins, or with carbon chains closed onto themselves commonly known as saturated cyclics or naphthenes);
unsaturated hydrocarbons (olefins with open or closed chains containing one or more double bonds);
aromatic hydrocarbons (one or more unsaturated cycles with aromatic nucleus);
oxygenated organic products: molecules containing at least one atom of oxygen (alcohols, aldehydes, ketone, esters, ethers, acids, etc.).

In the family of paraffinic hydrocarbons, the self-ignition delay decreases regularly as the length of the chain increases. In the family of isoparaffin-type hydrocarbons, the delay increases according to the number and complexity of the branches of the lateral chains. Likewise, the self-ignition delays of molecules with an aromatic nucleus are higher than those of molecules without such a nucleus.

Similarly, the self-ignition delay of molecules with one or more unsaturations is generally higher than that of paraffins with the same carbon backbone and the delay for these two families depends on the length of the branches in the chains. Finally, cyclic molecules, saturated or not, always have a longer self-ignition delay than their non-cyclic counterparts.

The controlled-spark engine according to the invention comprises an electronic/digital engine control module which includes at least one spark advance management system and means for determining the molecular structure of the fuel supplying said engine. These determination means are described, for example, in patent application FR 2,883,602. The analysis means make it possible to obtain at least one marker of the molecular structure of the fuel. The management system is arranged so as to adjust the value of the spark advance angle according to the marker of the molecular structure of the fuel supplied by the determination means.

The markers (c₁, c₂, . . . , cₙ) relating to the molecular structure of the fuel are linked/correlated with the self-ignition delay of the fuel and thus with the spark advance adjustment.

Thus, during the engine design phase, using at least one calibration database, one or several tables are drawn up showing the correlation between variations in the spark advance and one or more markers of the molecular structure of the fuel (FIG. 6). The table shown in FIG. 6 is stored in the ECU memory. Axes A₁ and A₂ make it possible to position the coordinates of the fuel on the X and Y axes; the vertical axis Z represents the adjustment advance values V_{A} in degrees of angle.

Based on these tables, the management system is arranged to determine a plurality of functions (a₁, a₂, . . . , aₙ) calculated according to the markers (c₁, c₂, . . . , cₙ) of the molecular structure of the fuel. The functions (a₁, a₂, . . . , aₙ), linear or otherwise, are sorted by descending order of correlation with the spark advance adjustment values.

The management system can also be arranged to determine at least one combination from among all possible combinations (O₁, O₂, . . . , Oₙ) of the functions (a₁, a₂, . . . , aₙ) of the molecular structure of the fuels. This combination is the optimum correlation with the self-ignition delay value of the fuel and the spark advance adjustment.

The correlation table makes it possible to determine the spark advance value according to:
at least one marker (c₁) and preferably 2 markers (c₁, c₂)
at least one function (a₁) and preferably 2 functions (a₁, a₂)
at least one combination (Oᵢ) and preferably 2 combinations (O₁, O₂)
or else a plurality of markers (c₁, c₂, . . . , cₙ)
or else a plurality of functions (a₁, a₂, . . . , aₙ)
or else a plurality of combinations (O₁, O₂, . . . , Oₙ)

For example, the functions (a₁), (a₂) and (a₃) are constructed as relating to the determination of the molecular structure criteria of aromatics, oxygenates and isoparaffins respectively, as described by the following equations:

(a₁)=(p*c₁)/(q*c₂),where c₁ is an aromatic marker and c₂ is a linear chain marker.

(a₂)=(u*c₃)/(v*c₄),where c₃ is an oxygenate marker and c₄ is an isoparaffin marker.

(a₃)=(w*c₅)/(x*c₂),where c₅ is an isoparaffin marker and c₂ is a linear marker.

p, q, u, v, w and x being constants.

In this example, O₁ can be determined as a combination of the functions (a₁, a₂) or (a₂, a₃) or (a₁, a₂, a₃) relating to the ability to resist self-ignition of the fuel. O₁ can be written, for example, as follows:

(O₁)=aa₁+ba₂+ga₃+e,where a,b,g and e are constants.

In our method, the spark advance management system is arranged so as to project the values of the chemical structure markers of the fuel (c₁, c₂, . . . , cₙ) or their functions (a₁, a₂, . . . , aₙ) or their combinations (O₁, O₂, . . . , Oₙ) in the correlation table or tables between the spark advance variation and the chemical structure marker or markers of the fuel or their combinations, the system being arranged so as to determine in this way the spark advance adjustment value in relation to the fuel.

These adjustment maps or tables are stored in a memory bank of the engine computer or of another computer connected to the main computer.

It is also possible to create one or more laws or mathematical models instead of the maps, said laws making it possible to calculate the spark advance value according to the markers or a function of the latter (a₁, a₂, . . . , aₙ), to store the law in a memory bank of the engine computer or in another computer connected to the main computer, and then to use the values of the chemical structure markers of the fuel as input variables of the law in order to determine the spark advance adjustment value.

In both cases, the adjustment value allows the engine computer to adjust the actuators in order to adjust the spark advance according to the new setting value.

This spark advance adjustment value according to the molecular structure of the fuel can be either a percentage of the advance value calculated “without fuel impact” or a number of degrees of advance to be subtracted from or added to the spark advance value calculated “without fuel impact”.

Management of the calculation of the spark advance adjustment value according to the chemical structure of the fuel can be carried out at every conventional step of determining the spark advance by the engine computer or during an additional step, or else by fractioning it and weighting it at each step. It is possible to apply the adjustment when calculating the initial spark advance from the starting phase of the vehicle and/or when calculating the spark advance after starting and/or during the final adjustment and correction according to the other sensor values and/or in an additional adjustment step.

In order to check the correct operation of the system, the computer performs a self-diagnosis process before applying the adjustment value and saving it to a storage memory bank. The saved adjustment values can be used as setting values if a fault is detected during self-diagnosis. Finally, the engine computer informs the engine diagnostics quality system of the results of the self-diagnosis.

In reference to FIG. 7, a method of optimising the spark advance management strategy is described based on an adjustment map according to markers of the molecular structure of the fuel.

This figure can therefore be summed up in the following steps:
Step 1: calculation of markers c₁ and c₂ of the molecular structure of the fuel (C) supplying the engine from the sensor (FS)
Step 2: the markers of the molecular structure of the fuel are projected according to the two axes A₁ and A₂ of the spark advance adjustment map (A₁, A₂, V_{A})
Step 3: the spark advance adjustment value (vₐ) for the given point C is determined according to the adjustment table (A₁, A₂, V_{A}) and the coordinates c₁ and c₂ of the fuel
Step 4: the spark advance management module of the engine control unit uses the adjustment value (Vₐ) to determine the optimum value of the advance setting
Step 5: the engine control unit activates the actuators.

The first step [1] in optimising the adjustment of the advance angle consists of determining the values of the chemical structure markers of the fuel (c₁, c₂ . . . ) by means of a fuel sensor (FS).

The second step [2] in optimising the adjustment of the advance angle consists of projecting the values of the chemical structure markers of the fuel (c₁, c₂ . . . ) in the correlation table or tables between the variation of the spark advance and the molecular structure of the fuel in order to determine the optimum advance adjustment value (VA) according to the molecular structure of the fuel. In this example, the adjustment value obtained from crossing c1 and c2 is 3% [3].

This value is recovered in the final calculation of the spark advance and the adjustment is made in an additional step [D] of the advance control strategy.

The engine computer adjusts the spark advance value by 3% and positions the actuators so as to respect the new setting.

According to several examples, the spark advance can be optimised as follows according to the markers used:

The markers (c₁, c₂, . . . , cₙ) include at least one linear marker relating to the length of the saturated and open linear carbon chains present in the fuel, the spark being delayed when the value of said marker increases.

The markers (c₁, c₂, . . . , cₙ) include at least one branched marker relating to the number of branches in the saturated and open linear carbon chains present in the fuel, the spark being advanced when the value of said marker increases.

The markers (c₁, c₂, . . . , cₙ) include at least one cyclic marker relating to the number of atoms contained in the saturated cycles present in the fuel, the spark being delayed when the value of said marker increases.

The markers (c₁, c₂, . . . , cₙ) include at least one unsaturated marker relating to the number of unsaturations of the olefinic open carbon chains present in the fuel, the spark being delayed when the value of said marker increases.

The markers (c₁, c₂, . . . , cₙ) include at least one aromatic marker relating to the number of unsaturated cycles with aromatic nucleus present in the fuel, the spark being advanced when the value of said marker increases.

The markers (c₁, c₂, . . . , cₙ) include at least one marker linked to the number of molecules containing at least one oxygen atom relating to the amount of oxygenated products present in the fuel, the spark being advanced when the value of said marker increases.

1. Controlled-spark engine comprising an electronic/digital engine control module, said module comprising at least one spark advance management system and means for determining the molecular structure of the fuel supplying said engine, said determination means making it possible to obtain markers of the molecular structure of the fuel, said engine being characterised in that the management system is arranged to use a plurality of functions (a₁, a₂, . . . , aₙ) for correlating the markers (c₁, c₂, . . . , cₙ) of the molecular structure of the fuel with the spark advance value, said functions (a₁, a₂, . . . , aₙ) being sorted by decreasing order of correlation with the spark advance adjustment values, in order to adjust the value of the spark advance angles according to said functions (a₁, a₂, . . . , aₙ).

2. Engine according to claim 1, characterised in that the markers (c₁, c₂, . . . , cₙ) relating to the molecular structure of the fuel are linked/correlated to the self-ignition delay of the fuel and thus to the spark advance adjustment.

3. Engine according to claim 1 or 2, characterised in that the markers (c₁, c₂, . . . , cₙ) include at least one linear marker relating to the length of the saturated and open linear carbon chains present in the fuel, the spark being delayed when the value of said marker increases

4. Engine according to claim 1 or 2, characterised in that the markers (c₁, c₂, . . . , cₙ) include at least one branched marker relating to the number of branches in the saturated and open linear carbon chains present in the fuel, the spark being advanced when the value of said marker increases.

5. Engine according to claim 1 or 2, characterised in that the markers (c₁, c₂, . . . , cₙ) include at least one cyclic marker relating to the number of atoms contained in the saturated cycles present in the fuel, the spark being delayed when the value of said marker increases.

6. Engine according to claim 1 or 2, characterised in that the markers (c₁, c₂, . . . , cₙ) include at least one unsaturated marker relating to the number of unsaturations of the olefinic open carbon chains present in the fuel, the spark being delayed when the value of said marker increases.

7. Engine according to claim 1 or 2, characterised in that the markers (c₁, c₂, . . . , cₙ) include at least one aromatic marker relating to the number of unsaturated cycles with aromatic nucleus present in the fuel, the spark being advanced when the value of said marker increases.

8. Engine according to claim 1 or 2, characterised in that the markers (c₁, c₂, . . . , cₙ) include at least one marker linked to the number of molecules containing at least one oxygen atom relating to the amount of oxygenated products present in the fuel, the spark being advanced when the value of said marker increases.

9. Engine according to claim 1, characterised in that the management system is arranged to use a combination (O₁, O₂, . . . , Oₙ) of the functions (a₁, a₂, . . . , aₙ) of correlating the molecular structure of the fuel with the spark advance value, said combination being the optimum correlation with the self-ignition delay value of the fuel and the spark advance adjustment.

10. Engine according to claim 1 or 9, characterised in that the management system is arranged to proceed with the construction of at least one adjustment table at least for correlation, said table making it possible to determine the spark advance value according to at least one marker of the molecular structure of the fuel (cᵢ) or at least one function of the markers of the molecular structure of the fuel (a) or a plurality of markers of the molecular structure of the fuel (c₁, c₂, . . . , cₙ) or a plurality of functions of the markers of the molecular structure of the fuel (a₁, a₂, . . . , aₙ) and/or of two markers of the molecular structure of the fuel (cᵢ, cⱼ) or of the best of two possible combinations of markers of the molecular structure of the fuel (Oᵢ and Oⱼ).

11. Engine according to claim 10, characterised in that it includes an engine computer, the adjustment table or tables being stored in a memory bank of said engine computer or of another computer connected to the engine computer.

12. Engine according to claim 11, characterised in that the spark advance management system is arranged to project the values of the chemical structure markers of the fuel (c₁, c₂, . . . , cₙ) or their functions (a₁, a₂, . . . , aₙ) or their combinations (O₁, O₂, . . . , Oₙ) in the correlation table or tables between the spark advance variation and the chemical structure marker or markers of the fuel or their combinations, the system being arranged so as to determine in this way the spark advance adjustment value in relation to the fuel.

13. Engine according to claim 1 or 9, characterised in that the management system is arranged to proceed with the construction of at least one mathematical model, said model making it possible to calculate the spark advance value according to at least one marker of the molecular structure of the fuel (cᵢ) or at least one function of the markers of the molecular structure of the fuel (aᵢ) or a plurality of markers of the molecular structure of the fuel (c₁, c₂, . . . , cₙ) or a plurality of functions of the markers of the molecular structure of the fuel (a₁, a₂, . . . , aₙ) and/or of two markers (cᵢ, cⱼ) or two combinations of markers of the molecular structure of the fuel (Oᵢ and Oⱼ).

14. Engine according to claim 13, characterised in that it includes an engine computer, the mathematical model for adjustment being stored in a memory bank of said engine computer or in another computer connected to the main computer.

15. Engine according to claim 14, characterised in that the management system includes a program stored in the microprocessor of the engine computer, said program using the calculated values of the chemical structure markers or one of the combinations as input variables of the mathematical model to determine the spark advance adjustment value.

16. Engine according to claim 11, characterised in that the adjustment value allows the engine computer to adjust the actuators in order to adjust the spark advance according to the new setting value.

17. Engine according to claim 1, characterised in that the spark advance adjustment value according to the molecular structure of the fuel is either a percentage of the advance value calculated or a number of degrees to be subtracted from or added to the spark advance value.

18. Engine according to claim 11, characterised in that the spark advance adjustment value according to the chemical structure of the fuel can be calculated at every step of calculating the spark advance by the engine computer or in an additional step.

19. Engine according to claim 1, characterised in that the adjustment value can be applied when calculating the initial spark advance, when starting the vehicle or when calculating the spark advance after starting or during the final adjustment and the correction according to the other sensor values or after the final adjustment and the correction according to the other sensor values.

20. Engine according to claim 11, characterised in that the computer is arranged to perform a self-diagnosis process before applying the adjustment value.

21. Engine according to claim 20, characterised in that the adjustment values are kept in a storage memory

22. Engine according to claim 21, characterised in that the stored adjustment values can be used as setting values if a fault is detected during the self-diagnosis.

23. Engine according to claim 22, characterised in that the management system is arranged so as to inform a general engine fault program EODB of the result of the self-diagnosis of the spark advance adjustment management.

24. Engine according to claim 14, characterised in that the spark advance adjustment value allows the engine computer to adjust the actuators in order to adjust the spark advance according to the new setting value.

25. Engine according to claim 14, characterised in that the spark advance adjustment value according to the chemical structure of the fuel can be calculated at every step of calculating the spark advance by the engine computer or in an additional step.
